(19) United States
(12) Patent Application Publication
(10) Pub. No.: US 2026/0264811 A1
(43) Pub. Date: Sep. 10, 2026

(54) SYSTEM FOR LOCKING AND UNLOCKING AN ELONGATE ELEMENT WITH SLEEVE AND TWO SECURING ELEMENTS, ONE AT EACH END OF THE SLEEVE

(71) Applicant: IFP Energies nouvelles, RUEIL-MALMAISON (FR)

(72) Inventors: Michel CASTAGNE, RUEIL-MALMAISON CEDEX (FR); Jerome JOUANIN, RUEIL-MALMAISON CEDEX (FR)

(21) Appl. No.: 18/876,227

(22) PCT Filed: Jun. 9, 2023
(86) PCT No.: PCT/EP2023/065505

§ 371 Date: Dec. 18, 2024

(30) Foreign Application Priority Data
Jun. 24, 2022 (FR) 2206309

(51) Int. Cl. B63B 21/08; F16G 11/04

(52) U.S. Cl. CPC B63B 21/08; F16G 11/048

(57) ABSTRACT

The invention is a system for locking/unlocking a cable 14 a support, having a sleeve with an orifice at each end for feeding the cable into and out of sleeve; a first securing element attached to the sleeve at a first end; a second securing element attached to the sleeve at a second end; and a spacer for increasing the distance between the first and second securing elements, to exert a tension on sleeve. The second securing element comprises at least two bodies which are movable in relation to each other, and a drive providing a first movement of one of bodies in relation to the other, with the first movement causing tightening of the sleeve on an elongate element 14 at the second end.

### CROSS-REFERENCE TO RELATED APPLICATIONS

Reference is made to PCT/EP2023/065505 filed Jun. 9, 2023, and French Application No. 2206309, filed Jun. 24, 2022, which are incorporated herein by reference in their entirety.

### BACKGROUND OF THE INVENTION

### Field of the Invention

The invention concerns the technical field of systems for locking and unlocking a substantially circular elongate element such as a cable or a rope. The main field of application is floating systems mooring. More specifically, the target main field of application concerns offshore power generation systems, among which anchoring of floating structures for wind turbines, oil & gas floating structures, floating photovoltaics, wave energy systems, floating substations, the generation of energy carriers such as hydrogen or ammonia. The system can also be used in any field requiring holding synthetic rope (aquaculture, sail transport, fishing, lifting systems, boating, . . . ) in position. The elongate element to be locked can be a metal or synthetic cable, or a rope.

### Description of the Prior Art

Locking and unlocking systems are generally used in the field of boating, or anchoring or mooring of boats or floating platforms, such as oil platforms or floating structures for wind turbines. The invention is more specifically intended for anchoring offshore oil platforms or floating wind turbines.

The main purpose of the mooring lines of a floating structure such as a wind turbine or oil platform is to keep the structure in position when it faces wind, current and wave forces. To fulfill this function, there are several mooring families (single point mooring and spread mooring for example) and mooring types, for providing more or less taut mooring (taut and semi-taut mooring for example) to catenary mooring.

Mooring lines consist of chains or metal cables, notably made of steel, or synthetic cables or a combination of chains and cables. Selection of the mooring type and of the material depends on the site (environmental conditions and water depth) and on the function of the floating structure (oil production, oil drilling, wind turbine, . . . ).

Mooring lines undergo high stresses notably related to wind, current and wave motion. These stresses may generate risks of mooring line fatigue failure. In addition, these natural phenomena cause displacement of the floating structure. Mooring lines therefore must have good resistance to induced stresses and enable limited movement of the floating structure.

Thus, tensions in the mooring lines of such wind turbine or oil platforms are very high (for example of the order of 5,000 kN for a floating wind turbine with taut lines and of the order of 1,500 kN for a floating wind turbine with catenary lines), and they are not comparable to the cable or rope tension values encountered in boating (to hoist and set the sails of a sailboat for example), of the order of 35 to 40 kN in boating or climbing, which are much lower.

Unlike boating or climbing cables and ropes that can be easily replaced, mooring lines can only be installed or replaced using heavy and expensive equipment. For example, to install or to replace three mooring lines of a floating platform for at least one of a wind turbine and the associated locking and unlocking systems for which at least three large boats whose daily rental is expensive are required. In addition, at least one of installation and replacement of these mooring lines and locking and unlocking systems can only be achieved under favorable weather conditions (slight swell, low wind notably). Thus, to install or to replace mooring lines, it is necessary to provide a significant intervention time, substantial and expensive equipment, with favorable weather conditions. Also, it may be necessary to anticipate these installations and replacements to avoid interventions during time windows under unfavorable weather conditions over long periods, notably in winter. It is therefore easy to understand that, for this type of platform, the service life of cables and of locking and unlocking systems is essential, and any wear and tear must therefore be prevented. Moreover, installation should be as fast and simple as possible.

Various techniques have been developed for locking a cable or a chain to a support (boat, barge or platform for example).

The simplest and best known technique is the splice, which consists in making a loop at the end of the cable by passing it back into itself (bury type splice) or by braiding it back with itself (tuck type splice). Various fastening systems can then be attached to this splice.

The splice does not allow length adjustment upon installation, let alone further adjustment over time.

Jaw locking systems, such as disclosed in French patent application FR-3,001,517, are also known. This system crushes the cable in the jaws over a short cable length, causes the cable section to change from a substantially circular section to an oval and/or flattened section when it is crushed. This causes fast wear of the cable.

Furthermore, locking systems that lock the cable by setting it in a sheath, which compresses the cable when the sheath is tensioned, are also known. Patent application WO-2012/172,272 and corresponding USpublished patent appplication 2014/223,967 concerns such a system.

The system provides effective locking. However, abnormal wear of at least one of the cable and the sheath is observed because the cable can slightly move within the sheath, which causes friction between the sheath and the cable. Indeed, the free end of the sheath (which is not anchored to the support) is simply held in tension by an elastic tensioning line, itself attached to the sheath at a single point. It is not integral with the cable. The tension applied by the line onto the sheath at a single point therefore does not generate a uniform tension at this end of the sheath. According to another variant, the free end of the sheath is arranged in a hub secured to a spring allowing holding it in tension. In this case, the sheath cannot contract in this hub and it can therefore not clamp onto the cable at this end.

### SUMMARY OF THE INVENTION

The technical problem to which the invention is directed is the design of a locking and unlocking system for an elongate element that allows adjustment both at the time of installation and after positioning, including when the elongate element to be locked is under tension. Furthermore, the locking and unlocking system must be suited to lock the elongate element under very high stress, as is the case with mooring lines for floating wind turbines or oil platforms, by limiting wear of the cable and of the locking and unlocking system in order to increase the service life thereof, and to avoid the need for replacement of at least one of the elongate element and of the locking and unlocking system throughout the life of the platform.

To meet this goal, the invention provides a system for locking and unlocking a substantially circular elongate element on a support, comprising:
a substantially tubular sleeve includinga sheath or a structure, the sleeve having an inner volume and first and second ends, the sleeve comprising a first orifice at the first end and a second orifice at the second end, the first and second orifices allowing the elongate element to be fed into and out of the sleeve;
a first securing element suited to be attached to the support, the first securing element being attached to the sleeve at or close to the first end, the first securing element comprising a first opening for passage of the elongate element;
a second securing element to which the sleeve is attached at or close to the second end; and
a spacer for increasing the distance between the first securing element and the second securing element, for exerting a tensile force on the sleeve to constrict the sleeve onto the elongate element.

Furthermore, the second securing element comprises at least two bodies which are movable in relation to each other, and a drive means providing a first movement of one of the bodies in relation to the other, the first movement causing reduction in diameter of the sleeve onto the elongate element at the second end, and thus tightening thereof.

The invention concerns a system for locking and unlocking a substantially circular elongate element on a support, comprising:
a substantially tubular sleeve including a sheath or a structure, the sleeve or structure having an inner volume and first and second ends, the sleeve or structure comprising a first orifice at the first end and a second orifice at the second end, the first and second orifices allowing the elongate element to be fed into and out of the sleeve;
a first securing element for attachment to the support, the first securing element being attached to the sleeve at or close to the first end, the first securing element comprising a first opening for passage of the elongate element;
a second securing element to which the sleeve or structure is attached at the second end; and
a spacer element for increasing the distance between the first securing element and the second securing element, for exerting a tensile force on the sleeve to constrict the sleeve to the elongate element.

Furthermore, the second securing element comprises at least two bodies which are movable in relation to each other, and drive providing a first movement of one of the bodies in relation to the other, the first movement causing tightening of the sleeve on the elongate element at the second end.

Advantageously, the second securing element comprises an outer part including a male body and a female body that are coaxial with the same axis, and a displacement device for displacing, along the axis of the male body and of the female body, one of the male or female bodies in the direction of the other male or female body, the male body comprising an outer surface inclined to an axis and an inner surface allowing passage of the elongate element, the female body comprising a conical inner surface whose angle relative to the axis is substantially equal to the angle of the inclined outer surface of the male body relative to the axis, the male body comprising at least three independent parts with the axial displacement exerted by the displacement device causing radial displacement of the at least three independent parts, in order to tighten the sleeve on the elongate element proximal to the second end.

Preferably, the inner surface of the male body comprises at least one convex curved portion.

According to an embodiment of the invention, the displacement device comprises a screw and threaded system, which is preferably a screw and a nut, which fits into an external thread or an internal thread of the outer part.

Advantageously, the displacement device allows displacement of the female body in the direction of the male body so that the male body moves only radially.

According to a configuration of the invention, the second securing element comprises two annular parts connected by curved strips in the direction of the sleeve, the second securing element comprising a displacement means for increasing or reducing the distance between the annular parts.

According to one implementation of the invention, the spacer means comprises at least one of a spring and a cylinder, such as a hydraulic, pneumatic or electrical cylinder.

Advantageously, the second securing element comprises a return means for displacement according to a second movement, preferably opposite to the first movement, of one of the bodies relative to the other, which causes loosening of the sleeve on the elongate element.

Preferably, the system comprises a translational guidance for guiding the displacement of the second securing element, preferably, the guidance comprises a part with a machined dovetail, the second securing element comprising an extension whose shape is complementary to the dovetail. Advantageously, the sleeve is attached to the second securing element.

According to an embodiment of the invention, the sleeve is a woven or braided or nonwoven sheath comprising at least one of metal fibers and ultrahigh-molecular-weight polyethylene or aramid fibers.

Preferably, the sleeve has a structure which comprises at least one preferably helically wound armor layer.

Advantageously, the second securing element comprises a stopping device for limiting the relative movement between the at least two bodies in relation to each other.

The invention also concerns a method for locking and unlocking an elongate element by use of a locking and unlocking system as described above, wherein at least the following steps are carried out for locking:
a) inserting the elongate element into the system from one of the first or second orifices towards the other of the first and second orifices to a locking position, and preferably exerting a tension on the elongate element,
b) once the locking position of the elongate element is determined moving the second securing element away from the first securing element to exert a tension on the sleeve, and then locking the second securing element onto the elongate element by displacing with a first movement one of the at least two bodies in relation to the other, or
   locking the second securing element onto the elongate element by displacing in a first movement one of the at least two bodies in relation to each other, and then moving the second securing element away from the first securing element to exert a tension on the sleeve,
c) if a tension has been exerted on the elongate element, releasing the tension on the elongate element,
and for unlocking:
   moving the second securing element closer to the first securing element to release the tension on the sleeve, then unlocking the second securing element from the elongate element by displacing, in a second movement preferably opposite to the first movement, one of the at least two bodies in relation to the other, or
   unlocking the second securing element from the elongate element by displacing, in a second movement preferably opposite to the first movement, one of the at least two bodies in relation to the other, then moving the second securing element closer to the first securing element to release the tension on the sleeve.

Advantageously, the support is a floating platform and, prior to carrying out step b) for locking, the floating platform is ballasted to increase its draft, and the floating platform is deballasted after step b).

### BRIEF DESCRIPTION OF THE DRAWINGS

Other features and advantages of the system and of the method according to the invention will be clear from reading the description hereafter of embodiments given by way of non-limitative example, with reference to the accompanying figures, wherein:

FIG. 1 shows a TLP (Tension Leg Platform) type floating structure equipped with mooring lines and with locking and unlocking systems according to the invention;

FIG. 2 shows a locking and unlocking system according to the invention, in place on a cable;

FIG. 3 shows the operation of an example of a second securing element of a locking and unlocking system according to the invention;

FIG. 4 shows an example of a male body of a second securing element of a locking and unlocking system according to the invention;

FIG. 5 is a 3D view of one embodiment of a locking and unlocking system according to the invention;

FIG. 6 shows a male body in several parts according to a first variant of a second securing element of a locking and unlocking system according to the invention;

FIG. 7 shows the working principle of a first variant of a second securing element of a locking and unlocking system according to the invention;

FIG. 8 shows an example of a first securing element of a locking and unlocking system according to the invention;

FIG. 9 shows a locking and unlocking system according to the invention with the first variant of the second securing element in locked position (a) and in unlocked position (b);

FIG. 10 shows a locking and unlocking system according to the invention with a spacer;

FIG. 11 is a partial view of the first variant of a locking and unlocking system according to the invention;

FIG. 12 is a sectional view of a second variant of a locking and unlocking system according to the invention;

FIG. 13 is a 3D view of a male body in one part independent of the second variant of a locking and unlocking system according to the invention;

FIG. 14 is a sectional view of a third variant of a locking and unlocking system according to the invention; and

FIG. 15 is a partial 3D view of the third variant of a locking and unlocking system according to the invention.

### DETAILED DESCRIPTION OF THE INVENTION

The invention is a system for locking and unlocking an elongate element on a support.

An “elongate element” is understood to be an element having a length greater than its other dimensions.

The elongate element can be a metal or synthetic cable, or a rope. The system according to the invention is particularly suited for synthetic cables because this type of cable has more space between the fibers and/or the strands, and they can therefore better be subjected to constriction. Moreover, the friction effects of this type of cable are greater than those of metal cables, which allows locking to be improved.

The locking and unlocking system can advantageously comprise the elongate element.

The elongate element can have a “substantially circular” section.

“Substantially circular” means that it globally has a circular section but, due to the potential presence of strands, it may have a not perfectly circular outer periphery.

The support can be a floating platform (oil, gas, wind turbine, a vessel for example), a person for climbing, a fixed structure for a lifting element, etc.

The locking and unlocking system comprises:
a substantially tubular sleeve having a sheath or a structure, the sleeve having an inner volume and first and second ends, the sleeve comprising a first orifice at the first end and a second orifice at the second end, the first and second orifices allowing the elongate element to be fed into and out of the sleeve;
a first securing element for attachment to the support, the first securing element being attached to the sleeve at or close to the first end, the first securing element comprising a first opening for passage of the elongate element, the first securing element providing connection (attachment) to the support and tensile stress take-up;
a second securing element to which the sleeve is attached at or close to the second end. Preferably, the second securing element surrounds the sleeve while being secured to the outer surface of the sleeve at or close to the second end;
a spacer for increasing the distance between the first securing element and the second securing element, to exert a tensile force onto the sleeve, a reduction in the diameter of the sleeve and thus a constriction (tightening) of the sleeve onto the elongate element. In other words, the sleeve exerts a constriction force on the elongate element when the sleeve is placed under axial tension. The spacer can be a spring or a cylinder. Alternatively, this spacer can be for a ballasting/deballasting. Indeed, on a platform ballasted by the ballasting/deballasting devices, the second securing element can be locked and, upon deballasting, the first securing element can rise with the platform (since it is attached thereto), thus moving away from the second securing element. It therefore grips the elongate element by constriction.

A sheath is understood to be at least one of a flexible material and a textile structure that is easily deformable (extensible), which preferably is a woven or braided textile. In the case of a sheath, at least one of the material and the textile structure that is deformable enough for tension on the sheath to cause deformation of at least one of the material and the textile structure which allows reduction of the diameter of the sleeve to tighten the elongate element. The properties of at least one of the material and the structure therefore advantageously enables tightening of the sheath around the elongate element. The notions of “flexible” and “easily deformable” are understood in relation to the elongate element which in other words, the sheath is more flexible and more easily deformable than the elongate element.

The structure is understood to be a deformable structure, for example an armor layer wound around the elongate element. The armor layer is advantageously made of a metallic material that deforms only slightly, in itself, under the effect of a tensile force. Thus, here, it is by the shape of the helical structure that the sleeve tightens on the elongate element as a result of the tension. Indeed, by applying a longitudinal tensile force on the helical armor layer, the diameter of the armor layer is reduced and therefore allows the elongate element to be tightened.

The sleeve is deformable, that is it has deformation capacities, notably constriction (diameter reduction) capacities, greater than those of the elongate element which allows tightening thereof.

The sleeve is substantially tubular because its section is contained between an outside diameter and an inside diameter that are coaxial. Of course, since the sleeve is deformable, the deformed sleeve may no longer be perfectly tubular. Thus, the “substantially tubular” feature refers here to the rest position, that is without tension on the sleeve. The sleeve has an inner volume and first and second ends (for example, the first end can be referred to as “upstream end” and the second end can be referred to as “downstream end”). Since the sleeve is capable of deforming, notably by constriction under the effect of a tension applied onto the sleeve, the inner volume is different between the rest position (no tension on the sleeve) and the operating position where a tension is applied on the sleeve and where the inner volume is thus reduced as a result of the constriction of the sleeve.

The sleeve is substantially elongate between the first and second ends thereof, with its length along the axis being the main dimension (the largest) of the sleeve.

What is meant by length is the length taken between the two ends of the sleeve, with the sleeve in rest position and substantially rectilinear.

The sleeve comprises a first orifice at the first end and a second orifice at the second end for feeding the elongate element into and out of the sleeve. These orifices therefore have diameters greater than or equal to the outside diameter of the elongate element, when the sleeve is in rest position. In other words, the first and second orifices allow passage of the elongate element through the sleeve. The elongate element can then be set in the inner volume of the sleeve, between the two ends thereof. In “rest position” of the sleeve, the inner volume allows the elongate element to slide in the sleeve, whereas when the sleeve is tensioned, the elongate element is locked in the inner volume of the sleeve.

According to one variant, the distance (length) between the first orifice and the second orifice can be greater than 5 times, preferably 15 times, the inside diameter of the sleeve (of the first and second orifices) in rest position. Indeed, it is advantageous to have a sufficient sleeve length so as to have a sufficient tightening force by use of the friction between the sleeve and the elongate element over a large surface, and distributed over the elongate element.

According to another variant, the distance (length) between the first orifice and the second orifice can be less than 15 times, preferably 10 times and more preferably yet 5 times, the inside diameter of the sleeve (of the first and second orifices) in rest position. Indeed, since the second securing element has been added, the tightening force has been improved and the length of the sleeve can be reduced. This configuration is also advantageous to reduce the size of the system.

The expressions “close to the first end” or “close to the second end” conveys that attaching the sleeve to the securing element concerned can be done in a more or less extended area, near the end concerned and preferably extending up to the end concerned.

When the sleeve is positioned to be rectilinear, the first and second orifices are advantageously coaxial so that tightening of the sleeve on the elongate element is properly distributed over the circumference and the length.

According to the invention, the second securing element comprises at least two bodies movable in relation to each other and a drive for driving a first movement of one of the bodies relative to the other, the first movement causing reduction in the diameter of the sleeve, and thus tightening of the sleeve on the elongate element at the second end. Thus, by of at least one body of the second securing element that can move in relation to the other, the sleeve can be tightened on the elongate element at the second end, homogeneously over the entire circumference. Thus, the elongate element can no longer move at this end, unlike systems of the prior art, which prevents friction and therefore wear of the sleeve and of the elongate element. The service life is thus extended, which is particularly advantageous for floating offshore platforms such as floating wind turbines, thereby allowing reducingthe costs and interventions related to changing elongate elements, such as mooring cables and associated locking and unlocking systems. The opportunity provided by the system is unlocking which notably facilitates the replacement thereof.

Furthermore, unlike securing systems for synthetic mooring cables using splices, the system makes it possible to set the mooring cable in place directly upon installation of the platform, without the need for an external tensioning system. Indeed, it is possible to pull on the cable upon this installation, then to lock it at the desired length using the locking and unlocking system. The floating platform can also be positioned in a temporary position (using ballasting for example), then progressively brought in a final position and held in this position by cables maintained at the suitable length by the locking and unlocking system.

According to a first embodiment of the invention, the second securing element can comprise an outer part including a male body and a female body that are coaxial around the same axis (the male body and the female body forming two bodies movable in relation to each other) and a displacement device for displacing along the axis (common to the male body and the female body) one of the male or female bodies in the direction of the other male or female body. The displacement device thus corresponds to a device for driving a first movement of one of the bodies relative to the other. By displacing one of the male or female bodies towards the other, the male body is driven radially in the direction of the sleeve while generating a reduction in the diameter of the sleeve.

Advantageously, the outer part can be cylindrical or it can at least have an inside diameter in which at least one of the male body and the female body can slide when driven by the displacement device.

For this first embodiment, the male body can comprise an outer surface inclined to the axis, for example this outer surface can be conical (at least partly conical), and the male body can also have an inner surface allowing passage of the sleeve and of the elongate element through the sleeve. The female body can have a conical (at least partly conical) inner surface with a cone angle substantially equal to the angle of the inclined (or conical) outer surface of the male body relative to the axis. In other words, the inner surface of the male body forms a second opening. The second securing element then surrounds the elongate element. The outer surface of the female body can be cylindrical for example, so as to facilitate at least one of fitting and sliding thereof within the outer part.

According to a first variant of the invention, the male body can comprise at least three independent parts so that the axial displacement exerted by the displacement device causes a radial displacement of the at least three independent parts, in order to reduce the diameter of the sleeve and thus to tighten the sleeve on the elongate element close to the second end.

The sleeve can be integrally attached to the male body (to the at least three independent parts of the male body for example), preferably on the inner surface or at one end of the male body (on the at least three independent parts of the male body for example), or the end of the sleeve can be locked longitudinally between the at least three independent parts of the male body.

The three independent parts are so configured that the inside diameter of the male body can be modified (increased or reduced) depending on their respective positions. Thus, the three independent parts allow a variation in the volume delimited by the inner surface of the male body, at least one of the male and female bodies being suited to slide within the outer part.

The three independent parts can advantageously be distributed over the circumference of the elongate element to exert a locking force (which can also be referred to as tightening force, tightening providing locking) distributed over the circumference. These three independent parts can be advantageously separated from each other by circumferential clearances that allow the inside diameter of the male body to be reduced upon tightening/locking.

According to a second variant of the invention, the male body can comprise a single independent part, this single independent part being configured to allow a reduction in the inside diameter of the male body for tightening the male body onto the elongate element. The male body can therefore be made of a deformable material such as at least one of plastic, an elastomer and comprising grooves to facilitate diameter reduction of the male body. Indeed, by means of the grooves, elastic deformation of the male body is possible without causing cracks or break of the male body. With a single independent part, the system is easier to install. Thus, the single independent part enables variation of the volume delimited by the inner surface of the male body, at least one of the male and female bodies being capable of sliding in the outer part.

The sleeve can be integrally attached to the male body (to the at least three independent parts of the male body or to the single independent part of the male body for example), preferably on the inner surface or at one end of the male body (of the at least three independent parts of the male body or of the single independent part of the male body for example). Alternatively, the end of the sleeve can be locked longitudinally in the male body serving as a longitudinal stop.

Preferably, the inner surface of the male body (of the at least three independent parts or of the single independent part for example) can comprise at least one convex curved portion. In other words, the inner surface of the male body has a portion that is curved in the direction of the elongate element. This convex curved portion allows generating progressive tightening of the body upon tightening start, to distribute the stress over the sheath and to avoid stress concentration.

Advantageously, the displacement device can comprise a screw thread system, preferably a screw or a nut, which engages into an external thread or an internal thread of the outer part. Thus, the displacement device can allow the first movement of one of the bodies towards the other to generate diameter reduction of the sleeve and locking, as well as the second movement, in the opposite direction to the first movement, of one of the bodies in the direction of the other so as to generate unlocking while increasing the diameter of the sleeve. Besides, this system is easy to implement.

Preferably, the displacement device is designed to allow displacement of the female body in the direction of the male body so that the male body (the at least three independent parts or the single independent part for example) moves only radially. Thus, for locking, the female body moves along the axis in the direction of the male body, thus driving the male body radially while reducing the inside diameter thereof. Thus, locking of the male body on the elongate element occurs without friction, while friction might appear if the male body had an at least partially axial movement upon locking. This configuration is therefore particularly advantageous for reducing both wear of the sleeve and wear of the elongate element.

According to a third variant, the second securing element can comprise two annular parts (annular plates for example) connected by curved strips in the direction of the sleeve, the second securing element comprising a displacement means for increasing or reducing the distance between the annular parts. The two annular parts may notably surround the sleeve. Using curved strips allows reduction of the diameter of the sleeve and thus locking the sleeve onto the elongate element at the second end, or to allow the elongate element to slide in the sleeve. By use of this displacement device, the two annular parts can be moved apart from each other, thus allowing the elongate element to slide in the sleeve; on the other hand, moving the two parts closer to each other causes locking of the elongate element in the sleeve at the second end, through contact between the curved strips and the sleeve.

The displacement means may be, for example, a cylinder, a cam system, a screw-nut system, etc.

The strips may be advantageously distributed over the periphery of the elongate element to provide a tightening force distributed over the elongate element at the second end.

According to a configuration of the invention, the spacer can comprise a spring, a screw-nut system and/or a cylinder, such as a hydraulic, pneumatic or electrical cylinder. These various systems make it easier to move the two securing elements away from or closer to each other. When the locking system is under water in a locked situation, the cylinder may be advantageous because the risk of seizure of the screw-nut system can be reduced and the effect of the corrosion that might affect the spring is also reduced. The spring has the advantage of fulfilling one of the locking or unlocking functions automatically. The screw-nut system allows manual actions enabling both locking and unlocking.

According to a configuration of the invention, the second securing element can comprise a return for displacement according to a second movement, preferably opposite to the first movement, of one of the bodies relative to the other, with the second movement causing loosening of the sleeve on the elongate element. It is thus possible to loosen the system, for example in order to modify the elongate element tension, notably when it is a mooring line that may creep or slacken over time, or require a tension change due to particular weather conditions (wind, thunderstorm, storm) and/or sea conditions (tide, swell, current).

By way of non-limitative example, the return device may comprise a lever.

When the second securing element comprises coaxial male and female bodies as described above, the second securing element can comprise a return for displacement, along the axis of the male body and the female body, of one of the male or female bodies in the opposite direction to the other male or female body, the return being preferably a return spring, or consisting of a displacement device that being reversible in this case.

Preferably, the return device is configured for displacement of the female body in the opposite direction to the male body, the male body only generating radial displacement, to avoid friction of the male body on at least one of the sleeve and of the sleeve on the elongate element.

According to an advantageous implementation of the invention, the system can comprise a translational guidance, a guide rail for example, for guiding the displacement of the second securing element relative to the first securing element. By use of this guidance element, the translation due to the spacer is rectilinear, which facilitates translation on the one hand and better ensures locking of the sleeve on the elongate element and unlocking thereof. The translational guidance is so configured that the first and second (cylindrical) orifices are coaxial.

Advantageously, the guidance can comprise a guide rail. Preferably, the guidance means can comprise a part with a machined dovetail, the second securing element comprising an extension whose shape is complementary to the dovetail. The complementary inner and outer shapes of the dovetail provide effective guidance in a simple manner.

Advantageously, the sleeve can be attached to the second securing element, preferably on an inner surface of the second securing element, for example on the inner surface of the at least three independent parts of the male body or on the inner surface of the single independent part of the male body, or on the inner surface of the strips. The sleeve is therefore integrally secured to the second securing element, and by providing displacement of one of the bodies relative to the other, the diameter of the sleeve can be increased or reduced, thus allowing the elongate element to slide within the sleeve or, on the contrary, to provide locking thereof.

According to an embodiment of the invention, the sleeve can be a woven or braided or nonwoven sheath, the sheath comprising metal fibers and/or ultrahigh-molecular-weight (UHMW) polyethylene or aramid fibers (which has the additional advantage of having a high friction coefficient). This type of sheath enables effective tightening on the elongate element, high frictional resistance and high mechanical strength. For example, the material of the sheath can be TECHNORA® (Teijin Aramid, Netherlands) or DYNEEMA® (DMC, Netherlands). A polyester sheath may also be considered. Polyester has an interesting frictional resistance and friction coefficient.

Alternatively or additionally, the sleeve can have a structure comprising at least one preferably helically wound armor layer. This structure allows diameter reduction when a tensional force is applied to the armor layer, while providing very high mechanical strength, which is particularly interesting for the mooring lines of floating platforms, such as offshore oil platforms or floating wind turbines.

Advantageously, the second securing element can comprise a stopping device for limiting the relative movement (relative translation for example) between the at least two bodies movable in relation to each other (between the male body and the female body for example). It is thus possible to limit the tightening applied to avoid damaging the sleeve or the elongate element. This stopping device can be advantageously adjusted (it may comprise an adjuster) in order to better control the tightening. For example, the stopping device can be a stop.

The invention also concerns a method for locking and unlocking an elongate element by means of a locking and unlocking system as described above, wherein at least the following steps are carried out for locking:
a) inserting the elongate element into the locking and unlocking system from one of the first or second orifices towards the other of the first and second orifices to a locking position, and preferably exerting a tension on the elongate element until a locking position is reached, which is advantageous for floating platforms, notably when the mooring lines of these floating platforms are taut or semi-taut,
b) once the locking position of the elongate element determined:
   moving the second securing element away from the first securing element using the spacer, so as to exert a tension on the sleeve, leading to a constriction of the sleeve and thus tightening of the sleeve on the elongate element, then locking the second securing element on the elongate element by displacing in a first movement one of the at least two bodies in relation to the other (for example, by displacing relatively one of the annular pieces with respect to the other, or by displacing relatively one of the male or female bodies towards the other male or female body, preferably by displacing the female body towards the male body, so that the male body (the at least three independent parts of the male body or the single independent part of the male body) moves only radially); or
   locking the second securing element on the elongate element by displacing in a first movement one of the at least two bodies in relation to each other (for example by moving one of the annular pieces towards the other or by displacing relatively one of the male or female bodies towards the other male or female body, preferably by moving the female body towards the male body so that the male body (the at least three independent parts of the male body or the single independent part of the male body) moves only radially), then moving the second securing element away from the first securing element so as to exert a tension on the sleeve.

These two ways ensure tightening of the sleeve onto the elongate element on the current portion and also at the second end, by using the second securing element with at least two bodies movable in relation to each other.
c) if a tension has been exerted on the elongate element, progressively releasing the tension on the elongate element. The tension on the elongate element is progressively transferred to the sleeve that is held on the portion of interest by use of the locking system. This progressive tension transfer to the sleeve also has the effect of exerting an additional constriction thereon, and thus to provide a better grip of the elongate element. For example, for a mooring line of a wind turbine platform, a winch may be provided to maintain the tension in the mooring line, initially for adjusting the length of the line. This position can then be locked by use of the locking system that tightens the mooring line in the sleeve of the system and at the second end of the sleeve. The second end is advantageously the one facing the sea bottom, whereas the first end is the one facing the winch. Once the line is locked in the locking system, the tension at the winch can be released, the tension being then taken up by the sleeve, and for unlocking:
   moving the second securing element closer to the first securing element so as to release the tension on the sleeve, then unlocking the second securing element from the elongate element by displacing in a second movement, preferably opposite to the first movement, one of the at least two bodies in relation to the other (for example by moving relatively one of the annular pieces towards the other or by moving relatively one of the male or female bodies in the opposite direction to the other male or female body, preferably by moving the female body in the opposite direction to the male body so that the at least three independent parts or the single independent part of the male body only move(s) radially) and possibly, the elongate element can be pretensioned with a winch or any other tensioning means in order to avoid overloads at the second securing element; or
   unlocking the second securing element from the elongate element by displacing in a second movement, preferably opposite to the first movement, one of the at least two bodies in relation to the other (for example by moving relatively one of the male or female bodies in the opposite direction to the other male or female body, preferably by moving the female body in the opposite direction to the male body so that the at least three independent parts or the single independent part of the male body moves only radially), then moving the second securing element closer to the first securing element so as to release the tension on the sleeve.

Advantageously, the support can be a floating platform and, prior to carrying out step b) for locking, the floating platform can be ballasted to increase its draft, and the floating platform is deballasted after step b). The setup operations are thus simplified and a tension can be easily generated in the mooring lines without it being necessary to pull on the cable.

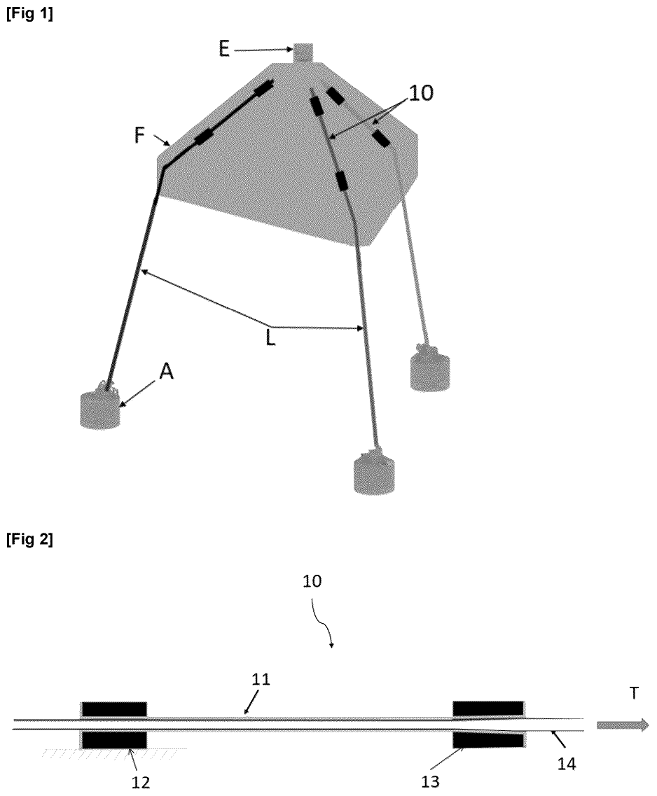

FIG. 1 schematically illustrates, by way of non-limitative example, a floating structure F equipped with mooring lines L and locking and unlocking systems 10 according to the invention for locking and unlocking mooring lines L.

A wind turbine E (of which only the lower part of the tower is shown) is arranged above floating structure F.

Of course, other types of floating structure could be used: barge, semi-submersible or spar.

Floating structure F is connected to the floor (sea bottom) by mooring lines L, three mooring lines L here, but of course a different number of mooring lines is possible without departing from the scope of the invention.

Mooring lines L are connected on the one hand to anchors A laid on or fastened to the floor (sea bottom) and, on the other hand, to a locking and unlocking system 10 according to the invention, itself attached to the floating structure. There is thus a locking and unlocking system 10 for each mooring line L. Locking and unlocking systems 10 can be positioned above the sea level, for example on the upper platform of the floating structure, or below the sea level (in this case, locking and unlocking system 10 is a subsea system).

Floating structure F of FIG. 1 is a taut-line structure for which a locking and unlocking system according to the invention is particularly advantageous. Indeed, a taut-line structure requires good precision in line length/line tension to ensure operation and stability, and it may be necessary to modify the mooring line length or tension adjustment over time, which can be done with the locking and unlocking system according to the invention.

However, other types of floating structures with catenary or semi-taut lines could of course be utilized without departing from the scope of the invention.

FIG. 2 schematically illustrates, by way of non-limitative example, a locking and unlocking system 10 according to the invention.

The locking and unlocking system is used to lock or unlock an elongate element 14 such as a cable, notably a synthetic cable.

Locking and unlocking system 10 comprises a first securing element 12 attached to the floating structure (floating structure F of FIG. 1 for example), a sleeve 11 (a textile sheath for example) and a second securing element 13.

Sleeve is fastened at a first end to first securing element 12, and at its second end to second securing element 13. An elongate element 14 such as a cable is set in locking and unlocking system 10, notably within sleeve 11 from a first end of the sleeve to the second end thereof. The distance between the first and the second securing element can be modified. When it increases, a tension is then applied onto sleeve 11, which generates a constriction effect from sleeve 11 on elongate element 14, thus allowing the elongate element to be locked in the system in the current portion of the sleeve.

The “current portion” is understood to be the part located far away from the ends and therefore, for the sleeve, the part that is neither in first securing element 12 nor in second securing element 13.

The locking and unlocking system is configured in such a way that elongate element 14 is locked in sleeve 11 and in second securing element 13, and second securing element 13 is positioned between first securing element 12 and the anchor point of the elongate element (anchor A of FIG. 1 for example).

Second securing element 13 comprises at least two bodies movable in relation to each other (not shown in the figure) so that a first movement of one of the bodies towards the other causes a reduction in the diameter of sleeve 11 and thus locking of the elongate element in sleeve 11 at the second end in second securing element 13. Elongate element 14 can be subjected to a tension T in the direction of its other anchor point (anchor A of FIG. 1 for example). This configuration is advantageous for taut and semi-taut lines.

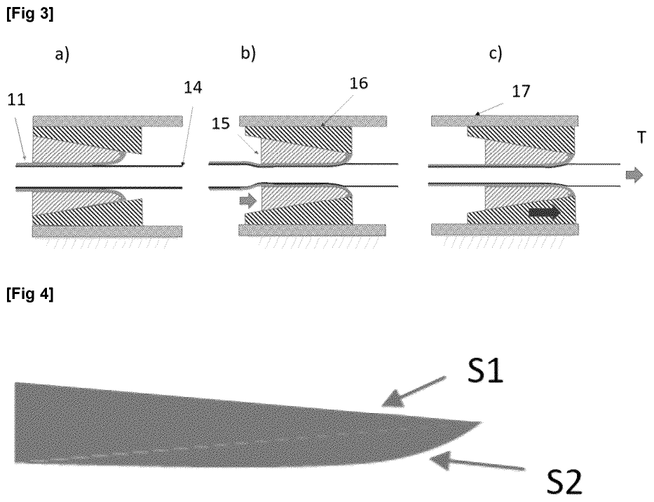

FIG. 3 schematically illustrates, by way of non-limitative invention, an example of a second securing element according to the invention.

The second securing element comprises a male body 15, a female body 16 and an outer part 17. The second securing element surrounds elongate element 14 and sleeve 11 wherein elongate element 14 is arranged, the sleeve itself being attached to the inner surface of male body 15.

Male body 15 comprises an inclined outer surface, conical for example, suited to fit into the conical inner surface of female body 16.

Female body 16 comprises a cylindrical outer surface substantially corresponding to the inner surface of outer part 17.

Male body 15 and female body 16 can move in relation to each other, and one or both the male and female bodies can move longitudinally in relation to the outer part.

In diagram a), the second securing element is in “rest” position (i.e. “not locked”). Elongate element 14 can slide in sleeve 11.

In diagram b), male body 15 has been moved in the direction of female body 16. Due to the contacting parts between male body 15 and female body 16, this movement generates a reduction in the inside diameter of male body 15. For this diameter reduction to be possible, male body 15 can be at least three independent parts, preferably separated by clearances, or it can be a single independent part, deformable so as to make the diameter reduction possible, for example by a structure making this constriction possible, notably using grooves and/or a deformable material such as elastomer or plastic.

The effect of the inside diameter reduction of the male body leading to a constriction of sleeve 11 and of elongate element 14 is observed. Thus, sleeve 11 tightens elongate element 14 at the second end of sleeve 11.

In diagram c), the assembly made up of male body 15 and female body 16 is moved within outer part 17 so as to drive the second securing element (or at least part thereof) away from the first securing element (not shown). This has the effect of tensioning sleeve 11 upstream (i.e. in the direction of the first securing element), and of generating a constriction of the sleeve, therefore tightening of sleeve 11 on elongate element 14 in the current portion.

The elongate element may or may not be subjected to a tension T.

FIG. 4 schematically illustrates, by way of non-limitative example, an example of a male body of a second securing element.

This male body comprises an inclined outer surface S1, conical for example, and a convex curved inner surface S2 which limits stress concentrations upon tightening the sleeve on the elongate element.

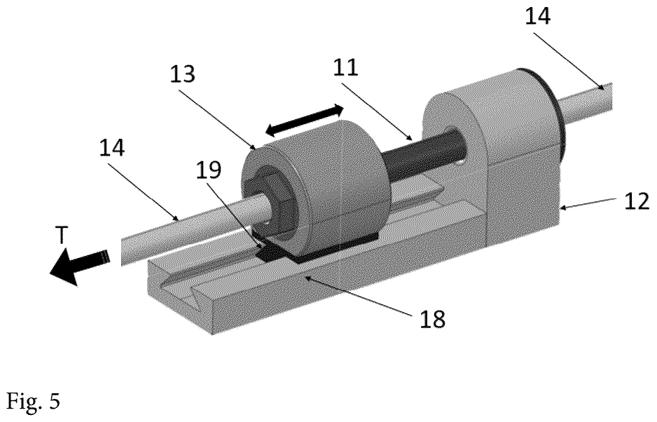

FIG. 5 schematically illustrates, by way of non-limitative example, a three-dimensional view of a locking and unlocking system according to the invention, for locking an elongate element 14.

The system comprises a first securing element 12 that can be attached to a support such as a floating platform for example, a second securing element 13 and a sleeve 11 in which elongate element 14 is suited to be set and suited to be locked.

Second securing element 13 can be moved relative to first securing element 12 by translation, preferably in the same direction as tensile force T that can be exerted on elongate element 14. In order to facilitate the translational guidance of second securing element 13 relative to first securing element 12, the first securing element can comprise an extension 18 in the direction of second securing element 13, this extension 18 comprising here a machined dovetail, but other solutions could also be used.

Furthermore, second securing element 13 comprises on the outer portion thereof (on the outer part for example) a machined extension whose shape 19 is complementary to that of the dovetail of extension 18.

These machined dovetails provide good guidance of second securing element 13 during its translation relative to first securing element 12.

The double arrow shows the displacement in two directions that can be applied to second securing element 13.

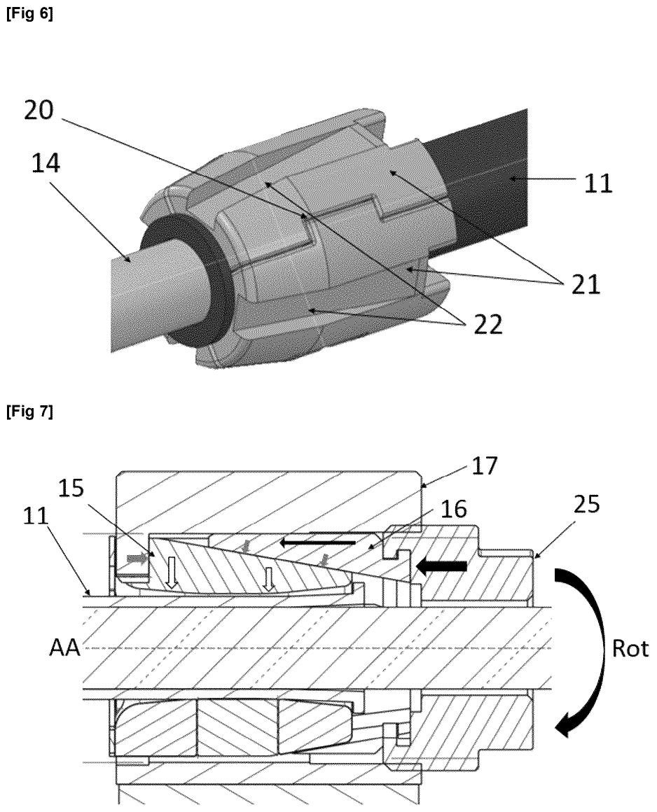

FIG. 6 schematically illustrates, by way of non-limitative example, a first variant of a second securing element. The male body has at least three independent parts 21. A sleeve 11 is attached to or at least locked longitudinally on the inner surface or at the end of independent parts 21 of the male body. Each independent part 21 comprises at least an inclined part 22 relative to the axis, on the outer surface, so as to fit into an inner conical (at least partly conical) surface of a female body (not shown).

An elongate element 14 is set in sleeve 11.

Independent parts 21 comprise sockets 20 allowing the various independent parts to be positioned relative to each other and facilitating displacement of the male body. Sockets 20 also keep the sleeve from getting stuck between two independent parts of the male body, which might cause pinching. As shown in the figure, the male body is in “locked” position. Indeed, in “rest” position (“unlocked”), the various independent parts would be separated by a clearance at least at sockets 20. While moving the male body, the clearance between the various independent parts decreases gradually, until it vanishes in “locked” position.

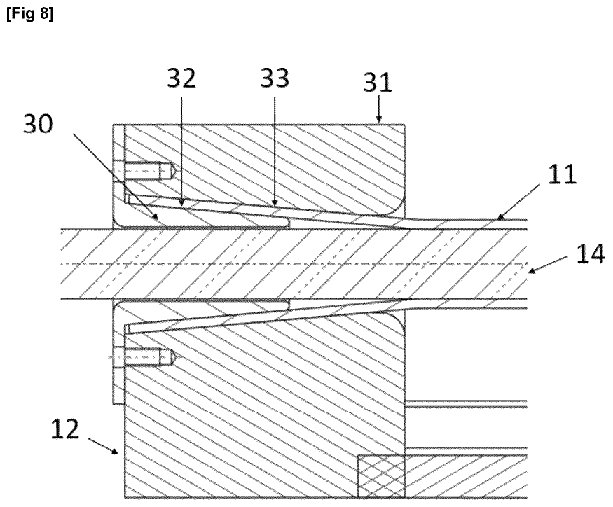

FIG. 7 schematically illustrates, by way of non-limitative example, the operating principle of the first variant of a second securing element according to the invention.

The second securing element comprises a male body 15, a female body 16 and an outer part 17, as well as a displacement device 25 having an external thread, such as a screw, suited to fit into an internal thread of outer part 17.

Sleeve 11 is attached to or locked longitudinally at the end of the inner surface of male body 15. This inner surface is convex curved, i.e. curved in the direction of sleeve 11.

The outer surface of male body 15 is at least partly inclined relative to axis AA, for example conical (at least partly conical), the inner surface of female body 16 is conical (also at least partly conical) and the angle of the outer surface of male body 15 inclined relative to the axis is substantially equal to the angle of the cone of the conical inner surface of female body 16.

When screw 25 is screwed into outer part 17 through a rotational movement Rot, female body 16 is driven to move in the direction of male body 15. The longitudinal end of male body 15 opposite female body 16 is stuck by a shoulder of outer part 17, so that the male body cannot be driven to move longitudinally along axis AA (axis of the sleeve and of the elongate element in the second securing element, corresponding to the axis of male body 15 and to the axis of female body 16).

Male body 15 being stuck by the shoulder of outer part 17, the longitudinal displacement of female body 16 causes radial displacement of male body 15 in the direction of sleeve 11, which generates a constriction of sleeve 11.

The opposite displacement (through a rotation in the opposite direction to rotation Rot) of screw 25 causes release of the pressures generated by locking and thus provides loosening of sleeve 11.

FIG. 8 schematically illustrates, by way of non-limitative example, a first securing element 12 according to an implementation of the invention. In this first securing element 12, sleeve 11 is stuck between an inner part 30 of conical upper surface 32 and an outer box 31 whose inner surface 33 is conical.

Inner part 30 can be fastened to outer box 31 by a flange.

Thus, at the level of this first securing element 12, there is no mechanism for tightening sleeve 11 on elongate element 14 at the first end of sleeve 11.

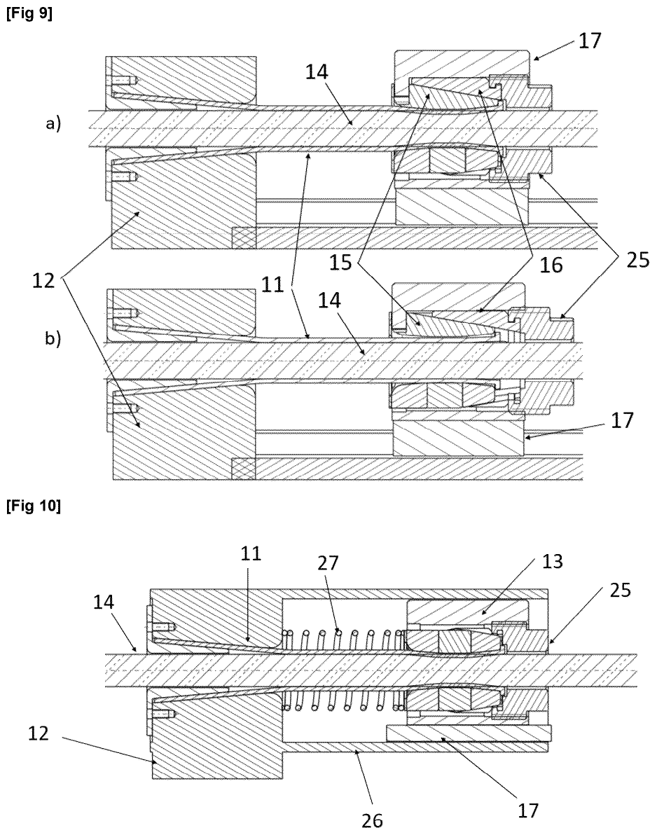

FIG. 9 schematically illustrates, by way of non-limitative example, a locking and unlocking system comprising a first securing element 12 of FIG. 8 and a second securing element 13 corresponding to the first variant of FIG. 7.

References identical to those in FIGS. 7 and 8 correspond to the same elements and are not detailed again here.

In diagram a), the second securing element is in locked position, nut 25 being pushed completely into outer part 17, female body 16 being then in its maximum position in the direction of male body 15, and male body 15 being at its maximum radial displacement in the direction of sleeve 11, which allows sleeve 11 to be tightened to the maximum towards elongate element 14 at the second end of sleeve 11.

In diagram b), the second securing element is in “rest” position (“unlocked”), nut 25 being loosened to the maximum from outer part 17, female body 16 being then in its maximum position in the opposite direction to male body 15, and male body 15 being at its maximum radial displacement in the direction of outer part 17, which allows sleeve 11 to be loosened to the maximum from elongate element 14 at the second end of sleeve 11. Elongate element 14 can then freely slide within the second securing element.

FIG. 10 illustrates a locking and unlocking system with a first securing element and a second securing element whose principle is similar to that of FIG. 9. Thus, references identical to those of FIG. 9 correspond to the same elements and are not detailed again here.

The locking and unlocking system comprises a spacer means consisting of a spring 27 positioned between first securing element 12 and second securing element 13. Spring 27 is configured to automatically drive second securing element 13 away from first securing element 12, and thus to generate a tension on sleeve 11, therefore a constriction force of sleeve 11 towards elongate element 14.

To loosen the elongate element, it is possible to push manually, or by means of an equipment that is not shown (cylinder, lever with cam or other pushing device), second securing element 13 towards first securing element 12. Besides, first securing element 12 comprises a substantially cylindrical elongate extension 26 in the direction of second securing element 13, this substantially cylindrical elongate extension 26 providing guidance for the longitudinal displacement (translation) (along the axis of elongate extension 26, which is also the axis of sleeve 11 attached in first securing element 12 and second securing element 13) of second securing element 13. As shown, outer part 17 of second securing element 13 can slide in substantially cylindrical elongate extension 26.

Spring 27 can thus be compressed (manually or using a pushing device) to feed elongate element 14 into the locking and unlocking system. Once elongate element 14 is positioned in the desired position (and possibly tensioned at a predetermined tension value), spring 27 can be decompressed. It is thus released and drives the sleeve in tension, thereby tightening sleeve 11 on elongate element 14 in the current portion. Nut 25 can then be screwed to move the female body towards the male body, and thus generate the radial displacement of the male body towards elongate element 14 in order to tighten sleeve 11 on elongate element 14 at the second end.

Nut 25 could also be screwed prior to decompressing spring 27.

FIG. 11 schematically illustrates, by way of non-limitative example, a partial three-dimensional view of a locking and unlocking system according to the invention.

Some parts are not shown so as to facilitate understanding.

Spring 27 serves as a spacer means for moving the second securing element away from the first securing element.

The second securing element comprises a male body 15 identical to the first variant described above. Male body 15 thus comprises several independent parts (at least three) with sockets 20 for fitting these independent parts together.

Female body 16 also comes in several parts that may or may not be independent, and they are configured to fit into the inclined parts (corresponding to reference 22 of FIG. 6) of the outer surface of the independent parts of male body 15.

Nut 25 can be screwed to drive female body 16 in the direction of male body 15, thus causing tightening of the sleeve on elongate element 14.

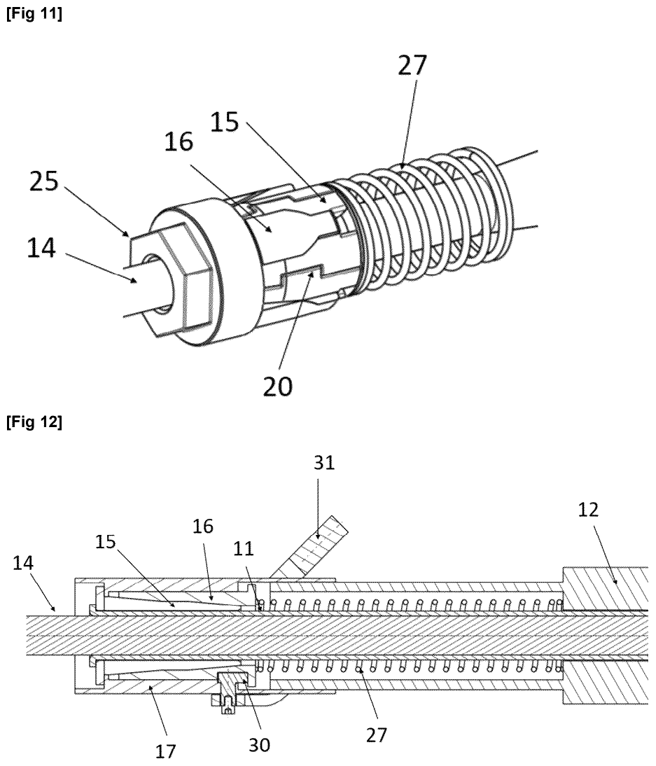

FIG. 12 schematically illustrates, by way of non-limitative example, a second variant of a locking and unlocking system according to the invention.

The locking and unlocking system comprises a first securing element 12, a sleeve 11 and a second securing element. A spring 27 positioned between first securing element 12 and the second securing element serves as a spacer means. Spring 27 surrounds sleeve 11.

The second securing element comprises an outer part 17, a male body 15 made of a single independent part and a female body 16. Male body 15 and female body 16 are coaxial (their common axis corresponding to the axis of the second securing element, i.e. of sleeve 11 in the second securing element). Sleeve 11 is attached to the inner surface of male body 15.

The outer surface of male body 15 comprises an inclined part relative to the axis, conical for example, suited to fit into the inner surface of female body 16 that also comprises a conical part. Therefore, the angle of the inclined part of the outer surface of male body 15 relative to the axis and the angle of the cone of the conical part of the inner surface of female body 16 are substantially equal.

Male body 15 is made up of a single independent part. For the inside diameter of male body 15 to be reduced or increased, at least one of the structure and the material thereof are configured to allow a variation in the inside diameter of the male body (for example, by means of grooves on the male body and/or using an elastomer or plastic material).

A drive device for driving female body 16 in the direction of the male body (or in the opposite direction) comprises a lever 31 that drives a shaft (not shown), itself driving a cam 30 operating so as to move female body 16 away from male body 15 when the cam is engaged on the female body. In a position where the cam does not drive female body 16 away from male body 15, spring 27 that acts as a spacer for driving the second securing element away from the first securing element also serves as a device for driving female body 16 towards male body 15.

Upon displacement (longitudinal translation along the axis common to male body 15 and female body 16) of female body 16 towards male body 15, male body 15 is driven radially towards sleeve 11 so that the inside diameter of male body 15 decreases. Therefore, the diameter of sleeve 11 is also reduced at the second end thereof (in the second securing element), which causes a constriction of sleeve 11 on the elongate element, allowing to lock it at this second end.

The second securing element (outer part 17 notably) can comprise an extension in the direction of first securing element 12, which also comprises an extension in the direction of the second securing element. These two extensions are configured to enable longitudinal translation in relation to each other, thus serving as a guide for the longitudinal translational displacement of the second securing element in relation to first securing element 12.

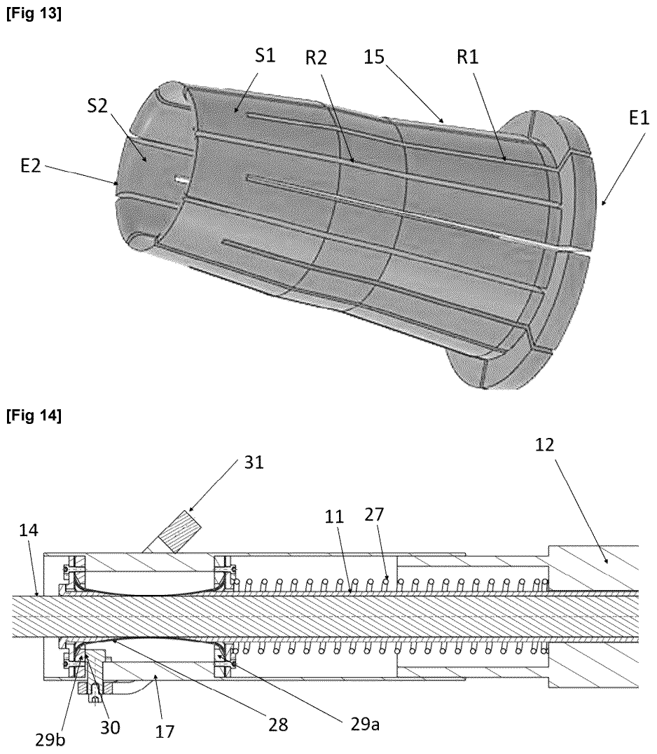

FIG. 13 schematically illustrates, by way of non-limitative example, an example of a male body 15 made of a single independent part for the second variant of the locking and unlocking system according to the invention, this second variant corresponding to that of FIG. 12 described above.

Male body 15 comprises an outer surface with at least a conical part S1 and an inner surface S2 to which the sleeve is attached.

Conical part S1 of the outer surface of the male body is designed to fit into the inner surface of the female body (not shown).

To enable reduction of the inside diameter of the male body when it is engaged in the female body, male body 15 comprises several grooves R1 and R2 extending longitudinally along the axis of male body 15 (the axis of conical part S1 of the outer surface of male body 15 notably), without running totally through male body 15 longitudinally (the grooves being longitudinally non-through).

First grooves R1 extend longitudinally from a first longitudinal end El of male body 15 and do not open in the other longitudinal end E2. These first grooves R1 pass through the thickness of male body 15 so they extend radially from the outer surface to inner surface S2.

Second grooves R2 extend longitudinally from a longitudinal second end E2 of male body 15 and they do not open in the other longitudinal end E1. These second grooves R2 pass through the thickness of male body 15 so they extend radially from the outer surface to inner surface S2.

This radial passage of the first and second grooves through the thickness of the male body allows male body 15 to deform and notably the inside diameter to be reduced. Moreover, using first and second grooves R1 and R2 that are longitudinally non-through (that is that open into only one of the first and second two ends El and E2) allows to keep a male body 15 in a single independent part.

First and second grooves R1 and R2 are evenly distributed over the circumference of male body 15, to generate a homogeneous deformation of male body 15 over the circumference thereof.

Furthermore, over the circumference, first grooves R1 and second grooves R2 follow one another alternately so that this succession of first and second grooves R1 and R2 allows the deformation of male body 15 to be homogenized.

By using these first and second grooves R1 and R2, male body 15 is adapted to be reduced in inside diameter (and reduced in outside diameter) when it is engaged in the female body, and when it is removed from the female body, the male body is adapted to be expanded in diameter and to recover its initial diameter, in “rest” position.

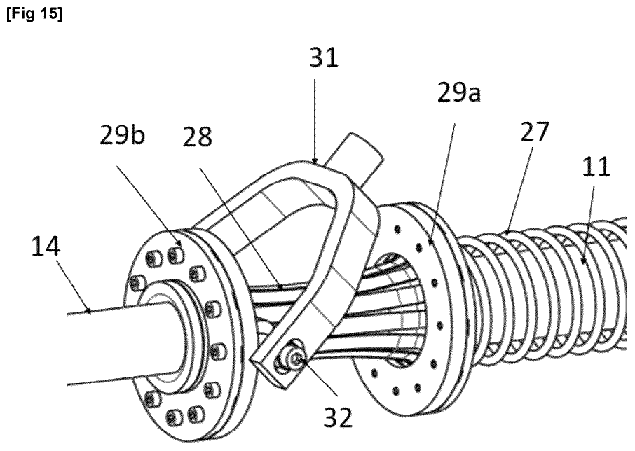

FIG. 14 schematically illustrates, by way of non-limitative example, a third embodiment of a locking and unlocking system according to the invention.

The locking and unlocking system comprises a first securing element 12, a sleeve 11 and a second securing element. A spring 27 positioned between first securing element 12 and the second securing element serves as a spacer means. Spring 27 surrounds sleeve 11.

The second securing element comprises an outer part 17, two annular parts 29a and 29b, and strips 28 each longitudinal end of which (along the axis of the second securing element, that is of sleeve 11 in the second securing element) is attached to a distinct annular part 29a/29b.

As shown in “rest” position in the figure, strips 28 are curved in the direction of the elongate element to facilitate tightening of sleeve 11 on elongate element 14 when the two annular parts 29a/29b are close to one another.

The second securing element (outer part 17 notably) can comprise an extension in the direction of first securing element 12, which also comprises an extension in the direction of the second securing element. These two extensions are configured to enable longitudinal translation in relation to one another, thus serving as a guide for the longitudinal translational displacement of the second securing element in relation to first securing element 12.

The second securing element also comprises a drive for driving one of the annular parts in the direction of the other. This drive comprises a lever 31 associated with a cam 30 allowing, depending on the position thereof, to move annular part 29b closer to annular part 29a (a first movement allowing tightening of sleeve 11 on elongate element 14 is then performed) or, on the contrary, to move annular part 29b away from annular part 29a (a second movement allowing loosening of sleeve 11 on elongate element 14 is then performed).

FIG. 15 schematically illustrates, by way of non-limitative example, a three-dimensional partial view of the third variant of the locking and unlocking system corresponding to FIG. 14.

In this figure, some parts are not shown for clarity reasons.

Spring 27 serves as a spacer for driving the second securing element away from first securing element 12.

The second securing element comprises two annular parts 29a and 29b separated and spaced apart by a plurality of strips 28 that are attached, at each end, to one of the two distinct annular parts 29a/29b. Sleeve 11 is attached to strips 28, on the inner surface of strips 28.

A drive allows annular parts 29a/29b to be driven away from or close to one another. This drive comprises a lever 31 rotatably driving a shaft 32, a cam being fastened to shaft 32. Thus, while operating lever 31, the cam rotates around the axis of shaft 32. Depending on the position of the cam, annular part 29b can be driven away from or close to annular part 29a, thus respectively leading to unlocking of sleeve 11 of elongate element 14 or, on the contrary, to locking of sleeve 11 on elongate element 14. Shaft 32 is advantageously pivotably connected to an outer part (not shown in FIG. 15 and corresponding to reference 17 of FIG. 14).

Of course, other embodiments can be considered without departing from the scope of the invention, notably different drives, different displacement devices, different returns, different spacers, and different guides.

1-15. (canceled)

16. A system for locking and unlocking a substantially circular elongate element on a support, comprising:
a substantially tubular sleeve comprising a sheath or a structure, the sleeve or structure having an inner volume and first and second ends, the sleeve or structure comprising a first orifice at the first end and a second orifice at the second end, the first and second orifices allowing an elongate element to be fed into and out of sleeve or structure;
a first securing element comprising a first opening for passage of the elongate element and for attachment to the support, the first securing element being attached to the sleeve or structure spaced from the first end,
a second securing element attached to the sleeve or structure at the second end;
a spacer for increasing the distance between first securing element and second securing element, which exerts a tensile force on the sleeve or structure that constricts the sleeve or structure on the elongate element and the second securing element comprises at least two bodies which are movable in relation to each other; and
a drive for providing a first movement of one of the bodies in relation to the other of the bodies that causes tightening of the sleeve on the elongate element at the second end.

17. A system for locking and unlocking an elongate element as claimed in claim 16, wherein the second securing element comprises an outer part including a male body and a female body that are coaxial on an axis, and a displacement device which displaces the male body and the female body along the axis, in a direction toward the other male or female body and wherein the male body comprises an inclined outer surface and an inner surface which allows passage of the elongate element, the female body comprising a conical inner surface forming an angle relative to the axis which is substantially equal to an angle formed by an inclined outer surface of the male body relative to the axis and the male body which comprises at least three parts so that an axial displacement exerted by the displacement device causes radial displacement of the at least three independent parts which tightens the sleeve on the elongate element relative to the second end.

18. A system for locking and unlocking as claimed in claim 17, wherein the inner surface of male body comprises at least one convex curved portion.

19. A system for locking and unlocking as claimed in claim 17, wherein the displacement device comprises a screw thread fitted into an external thread or an internal thread of an outer part of the system.

20. A system for locking and unlocking as claimed in claim 17, wherein the displacement device displaces a female body in a direction toward a male body by radially moving the male body.

21. A system for locking and unlocking as claimed in claim 16, wherein second securing element comprises annular parts connected by curved strips which extend in a direction of the sleeve or structure and means for displacing which increases or reduces a distance between the annular parts.

22. A system for locking and unlocking as claimed in claim 16, wherein the spacer comprises at least one of a spring and a cylinder.

23. A system for locking and unlocking as claimed in claim 16, wherein second securing element comprises a return for providing displacement, of one of the bodies relative to the other of the bodies with the second movement for loosening the sleeve on the elongate element.

24. A locking and unlocking system as claimed in claim 16, wherein the system comprises means for guiding the displacement of second securing element which includes a dovetail and the second securing element engages the first securing element and comprises an extension and which is shaped to be complementary to the dovetail.

25. A system for locking and unlocking as claimed in claim 16, wherein sleeve is attached to the second securing element.

26. A system for locking and unlocking as claimed in claim 16, wherein the sleeve is woven, braided or nonwoven and comprises at least one of metal fibers, ultrahigh-molecular-weight polyethylene and aramid fibers.

27. A system for locking and unlocking as claimed in claim 16, wherein the structure comprises at least one helically wound armor layer.

28. A system for locking and unlocking as claimed in claim 16, wherein the second securing element comprises a stop which limits relative movement between the at least two bodies.

29. A method of locking and unlocking an elongate element with a locking and unlocking system as claimed in claim 16, comprising steps of:
a) inserting the elongate element into the system from one of the first or second orifices towards the other of the first and second orifices to provide a locked position upon exerting tension on the elongate element; and
b) once the elongate element is in the locked position:
moving the second securing element away from the first securing element to exert tension on sleeve which locks the second securing element to the first elongate element by displacing one of the at least two bodies relative to the other body; or
locking the second securing element to the elongate element by displacing one of at least two bodies relative to each other, and then moving the second securing element away from the first securing element which exerts tension on the sleeve;
c) if tension has been exerted on the elongate element, releasing the tension on elongate element; and
unlocking the second securing element by:
moving second securing element closer to the first securing element to release the tension on sleeve, then unlocking the second securing element from the elongate element by displacing, with a second movement in a direction relative to the first movement, one of the at least two bodies in relation to the other body, or
unlocking the second securing element from the elongate element by displacing, in a direction relative to the first movement, one of the at least two bodies relative to the other and then moving second securing element closer to the first securing element to release the tension on sleeve.

30. A locking and unlocking method as claimed in claim 29, wherein the support is a floating platform and, prior to carrying out step b) ballasted a floating platform to increase draft thereof, and then deballasting the floating platform after step b).
